(19) United States
(12) Patent Application Publication
(10) Pub. No.: US 2024/0351901 A1
(43) Pub. Date: Oct. 24, 2024

(54) CARBON DIOXIDE REMOVAL USING FLASH CALCINED QUICKLIME

(71) Applicant: Mississippi Lime Company, St. Louis, MO (US)

(72) Inventors: Martin L. Gran, Chesterfield, MO (US); Paul Ramer, Ste. Genevieve, MO (US); Nathan Hooper, Farmington, MO (US); Elizabeth J. Vitale, Crystal City, MO (US)

(21) Appl. No.: 18/642,386

(22) Filed: Apr. 22, 2024

Related U.S. Application Data
(60) Provisional application No. 63/461,077, filed on Apr. 21, 2023.

(51) Int. Cl. C01F 11/06; C01F 11/18

(52) U.S. Cl. CPC C01F 11/06; C01F 11/18

(57) ABSTRACT

Systems and methods for using calcium oxide as a carbon dioxide capture tool. The calcium oxide is repeatedly formed from calcium carbonate and is reacted with calcium dioxide back to calcium carbonate where liberated calcium dioxide from calcination of the calcium carbonate is done in a flash calciner and liberated carbon dioxide is captured using a different carbon capture methodology. This method allows for carbon dioxide capture at a location where other methodologies would not be useable and where the stable and generally safe nature of calcium carbonate allows for efficient transport of captured carbon dioxide.

### CROSS REFERENCE TO RELATED APPLICATION(S)

This application claims the benefit of U.S. Provisional Patent Application Ser. No. 63/461,077, filed Apr. 21, 2023, the entire disclosure of which is herein incorporated by reference.

### BACKGROUND OF THE INVENTION

### Field of the Invention

This disclosure relates to uses for flash calcined quicklime. More specifically, this disclosure relates to using flash calcined quicklime to remove carbon dioxide (CO2) from gaseous mixtures.

### Description of the Related Art

Combustion of fossil fuels is typically used to produce heat. The heat may be used in industrial processes to drive certain chemical reactions, but is also often used to generate power. In a typical power plant, fuel is burned in a boiler to produce high-pressure steam, which drives a turbine to generate electricity. The exhaust gases from the combustion process are usually released into the atmosphere through a chimney or stack. Traditionally, the exhaust gas has been treated to remove various materials that are known pollutants of concern from the exhaust gas. For example, acid gases such as sulfur dioxide (SO2) and sulfur trioxide (SO3) have been removed to inhibit them from forming acid rain in the external environment or damaging process equipment.

Carbon dioxide (CO2) emissions have not traditionally been as controlled as other gases, but reduction of carbon dioxide emissions is gaining increased interest as increases in environmental carbon dioxide cause mounting concern. When fossil fuels such as coal, oil, and natural gas are burned, the combustion process produces large amounts of carbon dioxide as a byproduct and this carbon dioxide has traditionally simply been exhausted into the atmosphere. The amount of carbon dioxide emitted depends on the type of fuel, the efficiency of the combustion process, and the operating conditions specific to the activity.

Recently, there has become a strong interest in issues around increased atmospheric carbon dioxide and its effect on Earth's climate. Specifically, carbon dioxide is a greenhouse gas that, due to increased emissions from human activity, has been found to contribute to climate change and increasing concern over the effects of carbon dioxide production by human activity have resulted in a general desire to both reduce carbon dioxide emissions from various human processes and to potentially capture and reuse or sequester existing atmospheric carbon dioxide. While carbon dioxide is produced from a variety of sources, one major contributor is the combustion of fossil fuels in power generation and industrial processes.

Calcium oxide (CaO), which is commonly referred to as quicklime (or even just lime), is an incredibly useful compound with a storied history in a variety of industrial applications in all sorts of areas. Exemplary uses for calcium oxide range from many years ago where calcium oxide was heated to produce stage lighting (where the term “lime light” comes from) and as a building mortar for stone structures, to more modern uses where calcium oxide is an essential component of building materials such as cement, concrete, and plaster. Quicklime may also be used in agriculture to stabilize soils by reducing their acidity and increasing their pH levels and can be used in areas such as water treatment and other treatment processes as a way to remove impurities and contaminants.

Calcium oxide may also be used to produce calcium hydroxide, which is another useful compound used to remove impurities and contaminants. For example, calcium hydroxide may be used industrially as a flocculent in various processes including water and sewage treatment and for the scrubbing of acid gases from exhaust gas streams.

Calcium compounds have, in fact, been known to react with a variety of pollutants for a relatively long time. However, the necessity of fast reaction speed in pollutant removal, particularly in various flue gas treatment processes such as in-flight treatment of flue gas, originally meant that calcium compounds were relegated a secondary role in flue gas treatment in favor of other more highly reactive compounds. However, recent advances in the manufacture of calcium hydroxide to make it more highly reactive have resulted in it now being used in a number of pollution control activities. For example, highly reactive calcium hydroxide, has now found a place in removing acid gases from gas streams as contemplated in, for example, U.S. Pat. Nos. 9,751,043 and 11,311,839 the entire disclosures of which are herein incorporated by reference.

Calcium hydroxide and calcium oxide are both reactive with carbon dioxide. In fact, the production of calcium hydroxide and calcium oxide is typically performed in a manner that avoids prolonged air contact to avoid the calcium hydroxide and calcium oxide reacting with atmospheric carbon dioxide reducing process efficiency. Because of this reactivity, calcium hydroxide has previously been used to react carbon dioxide from gas streams as contemplated in U.S. Pat. No. 6,200,543 the entire disclosure of which is herein incorporated by reference. While calcium hydroxide has generally been considered a reasonable pollution control additive for post-combustion carbon capture, or more generally as a carbon capture, utilization, and storage (CCUS) technology, quicklime is typically not used because the reaction has often been considered far too slow and the process of obtaining calcium oxide generates carbon dioxide, making the process inefficient.

The reaction to turn calcium carbonate (CaCO3) into quicklime

CaCO(3)→CaO+CO(2)

specifically involves using heat (typically generated from fossil fuel combustion) to liberate carbon dioxide from the calcium carbonate. Thus, using calcium oxide as a reactant to remove carbon dioxide (which is basically the reverse reaction) is effectively a negative sum activity. Carbon dioxide is generated in the process to convert calcium carbonate into calcium oxide and carbon dioxide capture simply reverses the reaction meaning that the net capture (under ideal circumstances) is zero. Effectively, the calcium oxide simply recaptures the carbon dioxide it released in its creation. However, it is worse that that. The process of producing heat to power the reaction traditionally creates more carbon dioxide from the fossil fuel combustion to generate the heat. Thus, the formation of quicklime has created more carbon dioxide than the maximum carbon dioxide that can be removed by the quicklime even if the calcium oxide reaction itself operates perfectly. Obviously, the imperfect nature of the calcium oxide reaction with gaseous carbon dioxide in any real-world gas feed stream under normal process conditions means the production of calcium oxide produces more carbon dioxide than the calcium oxide can remove.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems, described herein, among other things, is the use of calcium oxide as a carbon dioxide capture tool. The calcium oxide is repeatedly formed from calcium carbonate and is reacted with calcium dioxide back to calcium carbonate where liberated calcium dioxide from calcination of the calcium carbonate is done in a flash calciner and liberated carbon dioxide is captured using a different carbon capture methodology. This method allows for carbon dioxide capture at a location where other methodologies would not be useable and where the stable and generally safe nature of calcium carbonate allows for efficient transport of captured carbon dioxide.

Further, the essentially infinitely repeatable nature of the conversion of calcium carbonate to calcium oxide and vice-versa allows for a system which, when combined with other carbon dioxide capture techniques which are more efficient for permanent renewal, but lack industrial applicability for carbon dioxide capture from gaseous sources such as flue exhaust streams, allows for improved carbon dioxide capture efficiency overall.

Because of these and other problems in the art, described herein, among other things, is a method for repeatable carbon dioxide capture comprising: calcining calcium oxide in a flash calciner from calcium carbonate; during said calcining, utilizing a carbon dioxide capture methodology to capture carbon dioxide liberated from said calcium carbonate; exposing said calcium oxide to carbon dioxide to react said calcium oxide back into calcium carbonate; returning said calcium carbonate to said flash calciner as calcium carbonate after said exposing; and repeating said calcining, said utilizing, said exposing, and said returning a plurality of times.

In an embodiment of the method the carbon dioxide capture methodology does not use calcium oxide.

In an embodiment of the method the exposing involves placing said calcium oxide in a bed and flowing fluid over said bed.

In an embodiment of the method the flowing fluid comprises environmental air.

In an embodiment of the method the flowing fluid comprises a flue gas.

In an embodiment of the method the flue gas is produced by a power plant.

In an embodiment of the method the flue gas is produced by a manufacturing process.

In an embodiment of the method the exposing occurs at a location remote to said calcining.

In an embodiment of the method the calcium carbonate is originally obtained from limestone.

In an embodiment of the method the calcium carbonate is originally obtained from seashells.

In an embodiment of the method the flash calciner utilizes electric heating.

In an embodiment of the method the electricity for said electric heating is from a renewable source.

In an embodiment of the method the exposing involves placing said calcium oxide on filter media in a fluid stream.

In an embodiment of the method the fluid stream comprises flue gas.

In an embodiment of the method the filter media is in a baghouse.

In an embodiment of the method the exposing involves placing said calcium oxide on an electrostatic precipitator (ESP).

In an embodiment of the method the exposing involves injecting said calcium oxide into a fluid stream.

In an embodiment of the method the fluid stream comprises flue gas.

### BRIEF DESCRIPTION OF THE DRAWINGS

FIG. 1 depicts an embodiment of the major components of a pollution control system in a flue gas stream for a typical power plant.

FIG. 2 depicts an embodiment of a flash calcination process that may be used to obtain calcium oxide in accordance with this application.

FIG. 3 depicts a comparison of carbon dioxide removal of a flash calcined quicklime versus a fine quicklime produced via pulverization after calcination.

FIG. 4 depicts a comparison of environmental carbon dioxide concentration over time in an ambient indoor environment comparing a flash calcined quicklime versus a fine quicklime produced via pulverization after calcination.

FIG. 5 depicts a comparison of environmental carbon dioxide concentration over time in a controlled environment with high humidity comparing a flash calcined quicklime versus a fine quicklime produced via pulverization after calcination

### DETAILED DESCRIPTION OF THE PREFERRED EMBODIMENT(S)

Calcium oxide should be a preferred carbon dioxide sorbent because the reaction is so simple and infinitely repeatable. Carbon dioxide reacting with calcium oxide produces calcium carbonate which is nontoxic, has a variety of commercial uses, and can also be recycled back into the same calcining process to liberate the previously captured carbon dioxide to recreate the same calcium oxide. However, because the primary source of calcium oxide is the calcining reaction which liberates carbon dioxide and generates excess carbon dioxide due to reliance on heat from fossil fuels, using it as a capture methodology has previously been ineffective.

However, calcium oxide can be a highly effective carbon dioxide sorbent when combined with the liberated carbon dioxide from its formation being captured by an alternative carbon dioxide capture methodology. This allows the calcium oxide to act as a capture sorbent, the resultant calcium carbonate to act as a safe and stable transport material, and the alternative technology to supply more permanent capture when returning the calcium carbonate back to calcium oxide. This process can be accomplished without net carbon dioxide production. The capture process can also be repeated using the “recycled” calcium oxide.

This recyclability, which may be called “calcium looping”, can allow for calcium oxide to be used in capture locations where more permanent or preferred capture methodologies are simply not suitable (e.g. because those methodologies require infrastructure which is simply impossible to provide at the necessary capture site). Further, calcium carbonate can be safely and easily transported with little risk of the carbon dioxide being inadvertently released and the calcium carbonate is generally not considered dangerous. Captured carbon dioxide may then be released from the calcium carbonate into an alternative capture system with the resultant calcium oxide being returned to use as a sorbent in an infinitely recyclable system. Alternatively, should the resultant calcium carbonate have a more valuable application (e.g. because of its physical properties due to having been through this process multiple times) it can also be used to permanently store some of the carbon dioxide captured.

The major issue in using calcium oxide as a capture sorbent is that the processes for producing calcium oxide have relied upon high temperature traditional lime kilns. Calcium oxide is typically produced by thermally decomposing limestone or seashells, each of which contains sufficient levels of calcium carbonate (CaCO₃), which is also known as calcite. The thermal decomposition of calcium carbonate may also be referred to as a lime burning process or calcination. There are a large number of different types of lime kiln designs available in modern calcium oxide production. Some designs are little changed from processes used hundreds of years ago, while others are of relatively modern design. While there are a huge number of different lime kilns, most industrial processes use one of only a relatively small number of different designs. The design of a given lime kiln is often selected based on desired output and available input, as certain types of lime kilns are better for producing calcium oxide with certain qualities and characteristics and/or for operating on certain kinds of limestone feed stocks.

However, performing lime calcination in a lime kiln has typically required very high temperatures. Calcination in a typical kiln is generally performed at well over 1000° C. and typically around 1300° C. To get temperatures this high has required the burning of substantial amounts of fossil fuels to produce sufficient hear and that process produces carbon dioxide. For this reason, the production of calcium oxide has traditionally always resulted in a production of excess carbon dioxide compared to what can be captured by the resultant calcium oxide.

Calcination, however, may also be performed via flash calcination. Flash calcined lime is a high surface area, high reactivity quicklime produced via fast calcination at lower calcination temperatures. These temperatures are typically in the range of about 900° C. to about 1100° C. The flash calcination process may be performed by a variety of different structures, but they have the advantage of operating at lower temperatures which reduces the total energy requirements. Further, the lower temperature can make it easier for the heat to be provided by mechanisms other than the combustion of fossil fuels. Specifically electric heaters may be safely used in the kinds of temperature ranges used by flash calciners and the electricity used by these may be generated by any means including those that do not produce carbon dioxide, such as renewable and nuclear generation. This can reduce or even eliminate the initial carbon dioxide production as little to no carbon dioxide may be produced in the generation of heat for thermal decomposition of calcium carbonate.

An embodiment of the process of calcium oxide formation begins with the procurement of calcium carbonate from a source of calcium carbonate. In an embodiment, such a source may initially be a limestone mine, quarry, or other source of calcium carbonate-baring rock. In other embodiments, the initial source of calcium carbonate may be seashells, other shells, or another animal-made source. In some other embodiments, the initial source of calcium carbonate may be precipitated calcium carbonate. In yet other embodiments, the initial source of calcium carbonate may simply be any commercial source of calcium carbonate. Finally, in some embodiments, the initial source of calcium carbonate may be any source known to persons of ordinary skill in the art.

Regardless of where the initial calcium carbonate is obtained, it should be recognized that most of the calcium carbonate used in the system and method, once in process, will comprise calcium oxide that has been purposefully exposed to carbon dioxide gas and has reacted therewith back into calcium carbonate. This recycled calcium carbonate material is then returned to be used as a source material to reform into calcium oxide. It should be recognized that such recycled material has an advantage that it may already be of desired particle size and structure due to the fact that it has been previously processed through the calcining process. In some embodiments, such recycled calcium carbonate may actually be a preferred input to the system as it take less energy to crush or break it to a desired size. It may also become increasingly porous (and potentially more reactive) as it repeats the recycling process.

While calcium carbonate should, in theory, be infinitely recyclable through the calcination and capture processes, it should be recognized that the resultant calcium oxide may, over time, become less (or more) effective at carbon dioxide capture. In particular, the ability to capture carbon dioxide may become slower over time as repeated recycling alters physical properties of the calcium oxide (e.g. the particles become smaller, less porous, or have a decreased BET surface area). Should this be the case, calcium carbonate (or generated calcium oxide) may be retired after a certain number of recycling operations, after it reaches a certain reduced level of reactivity, or for any other reasons. In this case, as calcium carbonate and calcium oxide both have wide commercial applications, the products may be used for those applications. It should be recognized that should the calcium carbonate be used, the carbonate effectively acts as a final repository for the carbon dioxide captured in the last round of capture by the calcium oxide.

Typically, the calcium carbonate source material will be preprocessed to have selected physical properties related to the sizing and size distribution of the particles of calcium carbonate. For example, in an embodiment, limestone may be milled, classified, and mixed to provide the desired particle size distribution, which may be any particle size distribution known to persons of ordinary skill in the art and preferred for the specific application of the limestone. For example, in an embodiment, the source of calcium carbonate will be refined using known limestone processes. In other embodiments, any process for refining the limestone or other source of calcium carbonate may be used. Such a new source of calcium carbonate may be combined with existing calcium carbonate which has already gone through the capture process to maintain desired physical characteristics of the resulting particulate composition.

Once the calcium carbonate has been procured and made into an appropriate source particulate composition, the calcium carbonate will be calcined using flash calcination. The calcium carbonate is heated to covert the calcium carbonate into carbon dioxide and calcium oxide.

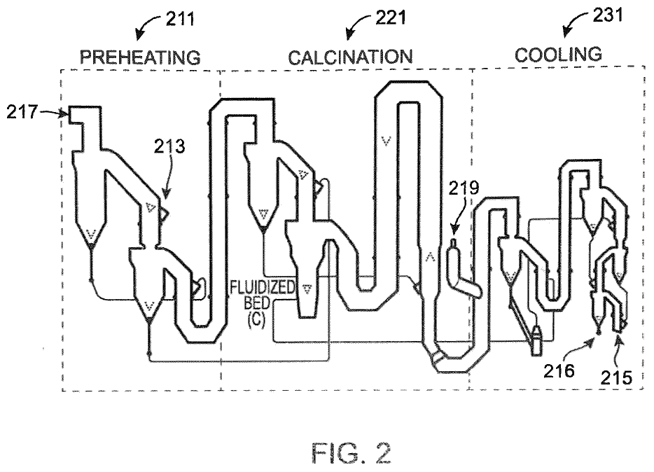

One method by which flash calcination may be performed is referred to as a “gas suspension calcination.” In this flash calcination process, an embodiment of which is depicted in FIG. 2, calcination takes place in a stationary vertical column within a gas suspension calciner. Milled limestone particles (or other source material) are rapidly calcined in an entrained-flow reactor, which is, in this context, referred to as a gas suspension calciner. Calcination may take place in a stationary vertical column (or in a system with such columns) within the gas suspension calciner. Typically, there are no rotating parts or grid plates in the gas suspension calciner, and the device may use simple proportional-integral-derivative control (also known as PID control) for the addition of fuel. The gas suspension calciner is typically a cascading system of interconnected ductwork and cyclone chambers, wherein the ductwork has a plurality of openings for the input of particles of calcium carbonate, hot air, and relatively cool air.

The process may be described as having three main stages: a first heating stage (211), a second calcination stage (221), and a third cooling stage (231). Air will typically enter the ductwork of the gas suspension calciner proximate to the end of the process in the third stage (231) at a cooling opening (215) and at the beginning of the second stage (221) at a heating opening (219). The exhaust gas from the process will typically leave the gas suspension calciner at the exhaust opening (217) and be exposed to an alternative carbon dioxide trapping process, material, or system. Typically, each of the cyclone chambers terminates at its bottom with a gravity fed portion of pipe that leads to one of several openings in the downstream portion of the ductwork, typically just upstream of the next cyclone chamber. This construction may be seen in FIG. 2.

Typically, small particles of a source of calcium carbonate, such as limestone, are preheated at a first stage (211). In some embodiments, such particles are less than one millimeter in diameter and feed is sized to pass a 100 micron mesh in one common embodiment. As depicted in FIG. 2, the source of calcium carbonate may be added to the process at a feedstock opening (213). The particles will typically first move vertically upwards, following the flow path of hot exhaust gas from the second stage (221). This flow path will typically deposit the particles of calcium carbonate into a cyclone chamber, mixing the exhaust gas and particles of calcium carbonate.

When the calcium carbonate reaches the bottom of the cyclone chamber, it may be conveyed to the second stage (221). Such conveyance may be any conveyance known to persons of ordinary skill in the art, such as the use of gravity. In the embodiment depicted in FIG. 2, there are two cyclone chambers in the first stage (201). Thus, the calcium carbonate may gravity feed from the first cyclone chamber into an area of the ducting just below the second cyclone chamber. Then, the preheated and dried calcium carbonate may be gravity fed from the second stage (221). Again, other types of conveyance may be used at any point during the flash calcination process.

At a second stage (221), the particles of calcium carbonate may be heated further to produce calcination. The calcination process may begin with an initial cyclone chamber that is followed by a fluidized bed reactor chamber, which chamber typically also features a cyclone action. This structure is depicted in FIG. 2. The heat for calcination is typically provided by an external air heater (not shown) that may also be configured to provide the source of calcium carbonate being calcined with the hot air. In the depicted embodiment, this heated air is introduced into the ductwork at a heating opening (219) within the ductwork. The heat for calcination may be produced by any method known in the art, including, without limitation, the combustion of any fuel material discussed above with reference to the burning of fuel in a lime kiln.

In the embodiments contemplated herein the air may be heated by other methods specifically including electrical or nuclear technologies which allow for the production of heat without the production of carbon dioxide. In some embodiments, as discussed in more detail below, the air within the gas suspension calciner may be conditioned air that has a reduced carbon dioxide content to avoid premature interaction of the calcium oxide with carbon dioxide.

In the depicted embodiment of FIG. 2, the calcium carbonate may enter the ductwork of the second stage (221) at a portion of the ductwork that is just upstream from the depicted initial cyclone chamber of the second stage (221). Like the cyclone chambers in the first stage (211), the initial cyclone chamber of the second stage (221) will mix the calcium carbonate with hot air in a cyclone, which hot air will typically be hotter than the hot air within the first stage (211). When the calcium carbonate reaches the bottom of the initial cyclone chamber, the calcium carbonate will typically gravity feed into a portion of the ductwork just upstream from the depicted fluidized bed reactor chamber. In the fluidized bed reactor chamber, the hot air will typically be hotter than the hot air within the initial cyclone chamber. Although the calcination process may begin in the initial cyclone chamber, such calcination may typically complete in the fluidized bed reactor chamber. Typically, the calcium carbonate will, at this point, have been converted (at least in part) to calcium oxide. The calcium oxide may now be gravity fed into the third stage (231).

At the third stage (231), the calcium oxide may now be cooled by mixing with cooler air introduced into the ductwork at the cooling opening (215). The third stage (231) may take many different forms. In the depicted embodiment, the third stage (231) comprises four separate cyclone chambers, with each gravity feeding the calcium oxide to the next in the sequence, one after another. Eventually, when the calcium oxide reaches the end of the final cyclone chamber (216), the calcium oxide may be removed from the gas suspension calciner for further processing.

In other embodiments, other flash calcination processes may be used. Typically, all flash calcination processes will share attributes and designs that comingle calcium carbonate in a fine, powdered form with hot gas, wherein the calcium carbonate typically moves through a continuous process against the main flow direction of the hot gas. Further, typical flash calcination processes will include some form of each of the first stage (211), second stage (221), and third stage (231), discussed above with reference to the depicted embodiment of FIG. 2.

Flash calcination is a preferred form of processing for a number of reasons. In the first instance, flash calcination, due to it's lower power (heat) requirements due to the lower calcination temperature, means that less energy needs to be used and the fact that such lower levels of heat may be more easily produced utilizing electric heaters and other methodologies which do not require combustion processes to generate the heat.

Further, flash calcination also typically produces a carbon dioxide stream from the reaction which is easier to sequester both from the heat generation and the calcination itself. This can be true even if fossil fuels, and particularly if cleaner burning fossil fuels such as, but not limited to natural gas, are used to generate the heat. A more concentrated carbon dioxide output, and particularly an exhaust stream from the flash calciner which has fewer elements that are not carbon dioxide can result in an easier ability to sequester the carbon dioxide produced using alternative methodologies.

Once the calcium oxide is produced, it will typically be sequestered from atmospheric carbon dioxide to maintain its effectiveness and speed of reaction in a resultant target environment. However, in an embodiment, if it is being used to remove environmental carbon dioxide, this is by no means required and environmental air may be purposefully introduced to actually encourage carbon dioxide capture therefrom. In such an embodiment, the calciner may actually be part of the sequestering process. Alternatively, the calcium oxide may be transported to an appropriate working site, or may be generated on site for use with a specific process. Regardless, the calcium oxide may be used as a sorbent for carbon dioxide wherever desired.

The reaction of any particulate composition with a particular gas in a gas stream is generally assumed to follow the diffusion mechanism. The targeted gas removal is the diffusion of target gas from the bulk gas to the sorbent particles. Thus, the total surface area of the sorbent (which is related to the mean particle size and particle size distribution within the composition) is believed to be very important. Specially, increased surface area implies faster reaction time and, thus, compositions with particles which are smaller than compositions with particles which are larger should be more reactive and better at quick reaction. Further, particulate sorbents which are more distributed, for example by being spread over filter media or injected directly in-flight are also expected to have more contact with the target gas and, thus, provide a quicker reaction.

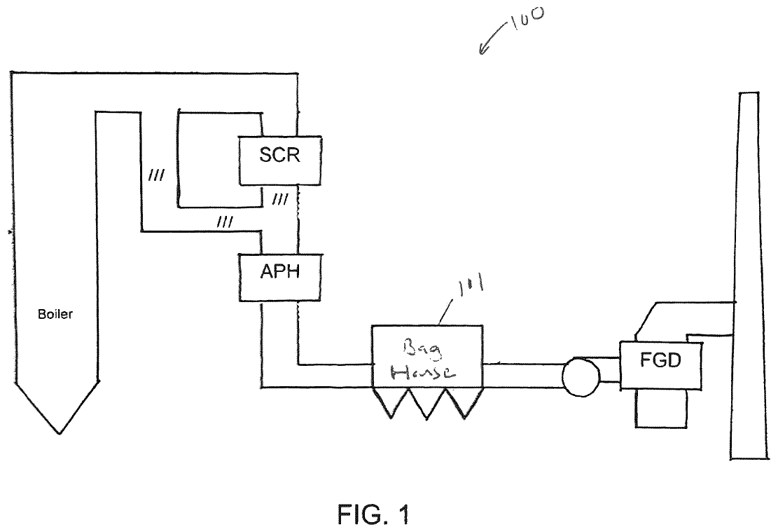

Removal of carbon dioxide from ambient air may be performed by simply providing beds of sorbent to the ambient although the ambient air is typically moved through or around the beds to provide increased contact. This is similar to reaction in a flue stream which is typically performed by either flowing the flue gas over a bed with a specific reactant in it (in this case carbon dioxide) or through a filter or other object which is gas permeable, but is coated by the reactant. In-flight neutralization of carbon dioxide gas is also possible and can be used in applications where a lower quantity of sorbent needs to be used to avoid clogging downstream elements of the flue duct with particulates. In an in-flight neutralization methodology the particulate sorbent is generally injected directly into the gas stream as a particulate spray. This is then believed to interact with the gas stream with the gas of interest reacting with the sorbent particles as the flue gas continues to traverse the exhaust. This will then typically result in a solid particle product being produced which is then filtered or otherwise captured later in the process. In a power plant or industrial process, such products are typically filtered out using a bag house or electrostatic precipitator (ESP) (101) in a flue gas stream (100) as illustrated in FIG. 1.

Capture within gas streams typically requires the particulate sorbent to avoid process problems which can reduce or eliminate the benefit of the carbon dioxide capture. Calcium oxide is well suited to this. Further, the produced calcium carbonate from the reaction is easily captured in a bag house bag (filter) as is excess unreacted calcium oxide added to the flue gas. The capture of the calcium oxide in the bag then results in further capture as gas continues to pass into the bag and remaining carbon dioxide is reacted with the trapped calcium oxide. As the bag effectively becomes more clogged with particulates, the carbon dioxide removal will potentially increase (although there will be negative air flow effects). Both calcium carbonate and calcium oxide are both easily and safely removed from the bag and recycled into new calcium oxide, so long as an alternative carbon dioxide capture methodology as contemplated above is used in the calcium oxide formation at a different site. As indicated above, carbon dioxide which is generated (liberated) from the calcium carbonate to calcium oxide reaction both initially when the calcium oxide is created and when the calcium carbonate is returned after having been used in a capture operation will still need to be captured by another technology to sequester it more permanently. In an embodiment, this released carbon dioxide is the initial carbon dioxide liberated by the thermal decomposition of virgin calcium oxide. In an alternative embodiment, the calcium carbonate will actually be calcium oxide that was previously reacted with a gas stream to capture carbon dioxide from that gas stream. While the use of conditioned air (air with reduced carbon dioxide content) has already been used to cool and heat the calcium carbonate in a number of processes to improve reaction efficiency, this does not actually capture the liberated carbon dioxide from the calcination reaction (although it may remove additional carbon dioxide from the air).

In order to recapture the liberated carbon dioxide from calcination and/or from the heat generation process driving the calcination, an alternative technology may be used. In this first instance, this alternative technology can be the use of an alternative sorbent such as, but not limited to, activated carbon, zeolites, amine-based sorbents, metal-organic frameworks (MOFs), or ionic liquids. Alternatively, since the carbon dioxide capture from the thermal decomposition of calcium carbonate can occur at a location remote from the capture, location specific technologies can be used. For example, the carbon dioxide produced by a flash calciner may be more easily sequestered by technologies such as those that utilize underground water and as may be described in U.S. patent application Ser. No. 17/126,967, the entire disclosure of which is herein incorporated by reference. The released carbon dioxide may also be itself directly captured and reused. As it is possible for the exhaust stream of the calciner to be essentially pure carbon dioxide (possibly in a carrier gas such as atmospheric air or a selected inert gas), the carbon dioxide may be, for instance, captured and cooled to produce liquid or solid carbon dioxide, which can then be resold and/or used in other processes requiring carbon dioxide.

In addition to the flexibility and non-toxicity provided by calcium oxide capture, it has also been determined that the typically smaller particle size and particle size distribution of calcium oxide which is produced by flash calcining can make the particles particularly adept at carbon dioxide capture in an industrial process such as interaction in flue gas and for environmental capture when compared to calcium oxide which is produced in more conventional kiln burning methodologies. Specifically, without being bound by any particular theory of operation, it is believed that a flash calcination process where limestone is typically pulverized to the desired size of the resultant calcium oxide before calcination may help preserve surface irregularities in the resultant calcium oxide increasing its effective surface area. In traditional kilns, where larger calcium particles are calcined and the calcium oxide is then pulverized to size after thermal decomposition, surface irregularities in the calcium oxide may be damaged or destroyed by the pulverization process reducing the effective surface area and reducing reactivity. Further, additional reuse and recycling of calcium oxide to calcium carbonate and back again without any additional pulverization may produce additionally reactive particles and/or preserve the reactivity level.

### Example 1

A small-scale test apparatus was designed and constructed to quantify the performance of various types of fine quicklime in an ambient air carbon dioxide removal application. Carbon dioxide removal is of interest in various point-source and ambient “direct air capture” applications for reduction of atmospheric carbon dioxide.

Two different fine quicklime sorbents were metered into a 4″ diameter pneumatic conveying line using a screw feeder. One sorbent composition was produced via calcination of calcium carbonate to calcium oxide in a traditional rotary kiln which calcium oxide was then pulverized and filtered via a 100 micron mesh filter. The second sorbent composition was produced via flash calcination from a calcium carbonate which was filtered via a 100 micron mesh filter prior to decomposition and then flash calcined and not further pulverized. In both cases, the quicklime/ambient air mixture was delivered to a bag style dust collector where the quicklime coated the dust collector bags. Air flow was approximately 175 SCFM and lime was fed at a rate of approximately 3 lbs./minute into the gas stream itself prior to the bag. Residence time in the conveying line was ˜1 second and the material was allowed to coat on the bags of the dust collector. Ambient carbon dioxide levels were measured at the inlet of the system and at the air discharging the dust collector at 1 minute intervals to quantify carbon dioxide removal by the system throughout this data collection period.

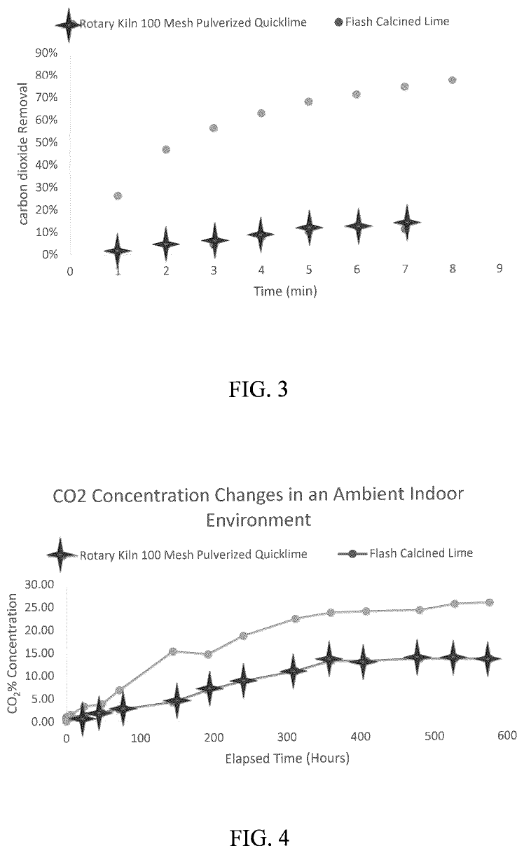

During testing and as illustrated in FIG. 3, it was found that utilizing a flash calcined lime provided a significantly higher removal of carbon dioxide compared to what would be considered one of the highest reacting quicklimes produced by current commercial methods. This type of system utilizing flash calcined lime could be particularly advantageous for carbon dioxide removal (CDR) such as for direct air capture using ambient air or as a point source capture tool (dry sorbent injection).

### Example 2

Flash calcined lime (as contemplated in Example 1) was also observed alongside the previously mentioned fine quicklime of Example 1 in different environments with varying temperatures and humidities over an extended period of time. Samples (˜7 g each) were exposed to an ambient indoor environment and collected at different times for about 4 weeks. (˜50% average relative humidity, ˜21 C). The study showed that flashed calcined lime removes CO2 from an ambient indoor environment at a faster rate than a conventional fine quicklime product (FIG. 4). The CO2% content of the lime product was measured to quantify the amount of calcium carbonate in the sample following air exposure which indicates CO2 absorbed from the environment.

### Example 3

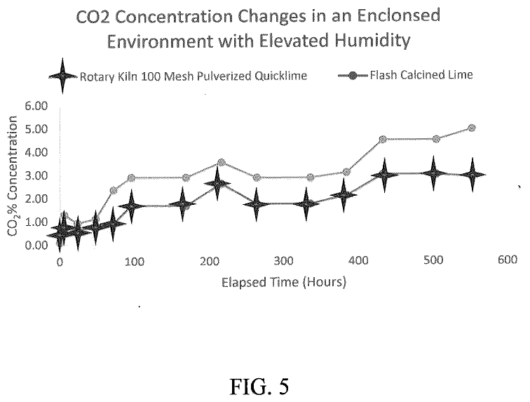

The two products of Example 1 were also exposed to an enclosed environment with a more controlled air input with elevated air moisture content (˜40% relative humidity, ˜24 C). Samples (˜10 g each) were collected at different times over about 4 weeks. As indicated in FIG. 5, results show that flash calcined lime did remove CO2 from the environment at a faster and more consistent rate than the pulverized quicklime of standard production.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This may be because related terms are purely geometric constructs having no real-world equivalent (for example, no sphere is every perfectly spherical), or there may be other reasons why a given term may be more precise than its real-world equivalent. Variations from geometric, mathematical, and other descriptions are unavoidable due to, among other things, manufacturing tolerances resulting in shape variations, defects and imperfections, non-uniform thermal expansion, and natural wear. Moreover, there exists for every object a level of magnification at which geometric, mathematical, and other precise descriptors fail, due to the nature of matter. One of ordinary skill would thus understand the term “generally” and relationships contemplated herein, regardless of the inclusion of such qualifiers to include a range of variations from the literal geometric, mathematic, or other meaning of the term in view of these and other considerations.

1. A method for repeatable carbon dioxide capture comprising:
calcining calcium oxide in a flash calciner from calcium carbonate;
during said calcining, utilizing a carbon dioxide capture methodology to capture carbon dioxide liberated from said calcium carbonate;
exposing said calcium oxide to carbon dioxide to react said calcium oxide back into calcium carbonate;
returning said calcium carbonate to said flash calciner as calcium carbonate after said exposing; and
repeating said calcining, said utilizing, said exposing, and said returning a plurality of times.

2. The method of claim 1, wherein said carbon dioxide capture methodology does not use calcium oxide.

3. The method of claim 1, wherein said exposing involves placing said calcium oxide in a bed and flowing fluid over said bed.

4. The method of claim 3, wherein said flowing fluid comprises environmental air.

5. The method of claim 3, wherein said flowing fluid comprises a flue gas.

6. The method of claim 5, wherein said flue gas is produced by a power plant.

7. The method of claim 5, wherein said flue gas is produced by a manufacturing process.

8. The method of claim 1, wherein said exposing occurs at a location remote to said calcining.

9. The method of claim 1, wherein said calcium carbonate is originally obtained from limestone.

10. The method of claim 1, wherein said calcium carbonate is originally obtained from seashells.

11. The method of claim 1, wherein said flash calciner utilizes electric heating.

12. The method of claim 1, wherein electricity for said electric heating is from a renewable source.

13. The method of claim 1, wherein said exposing involves placing said calcium oxide on filter media in a fluid stream.

14. The method of claim 13, wherein said fluid stream comprises flue gas.

15. The method of claim 14, wherein said filter media is in a baghouse.

16. The method of claim 1, wherein said exposing involves placing said calcium oxide on an electrostatic precipitator (ESP).

17. The method of claim 1, wherein said exposing involves injecting said calcium oxide into a fluid stream.

18. The method of claim 17, wherein said fluid stream comprises flue gas.
